(19) United States
(12) Patent Application Publication
(10) Pub. No.: US 2026/0303242 A1
(43) Pub. Date: Oct. 1, 2026

(54) METHOD FOR CONFIGURING A CHANNEL MODEL FOR SIGNAL TRANSMISSION BETWEEN A TRANSMITTER AND A RECEIVER AND TEST DEVICE

(71) Applicant: Rohde & Schwarz GmbH & Co. KG, Muenchen (DE)

(72) Inventor: Stefan SCHMIDT, Muenchen (DE)

(21) Appl. No.: 19/539,867

(22) Filed: Feb. 13, 2026

(30) Foreign Application Priority Data
Apr. 1, 2025 (DE) 10 2025 112 705.0

(51) Int. Cl. H04B 17/391; H04B 7/0413

(52) U.S. Cl. CPC H04B 17/391; H04B 7/0413

(57) ABSTRACT

The present disclosure relates to a method for configuring a channel model for signal transmission between a transmitter and a receiver. N delays of the signal transmission between the transmitter and the receiver, and an S×U scheme for the transmission channel between the transmitter and the receiver are configured, wherein S is the number of transmitting antennas and U is the number of receiving antennas. The channel model includes a total of M×N×S×U subpaths, wherein M is the number of subpaths per delay. Each of the M×N×S×U subpaths is completely described by a 3-tuple. Furthermore, a test device for simulating a signal transmission between a transmitter and a receiver is described.

### CROSS-REFERENCE TO RELATED APPLICATION

This application claims priority to German Application No. 10 2025 112 705.0, filed on Apr. 1, 2025, the entire disclosure of which is enclosed herein in its entirety.

### FIELD OF THE DISCLOSURE

Embodiments of the present disclosure relate to a method for configuring a channel model for signal transmission between a transmitter and a receiver, in particular a method for configuring a channel model for simulating signal transmission between a transmitter and a receiver. Furthermore, embodiments of the present disclosure relate to a test device for simulating signal transmission between a transmitter and a receiver.

### BACKGROUND

It is known from the prior art that different channel models can be used to simulate signal transmission between a transmitter and a receiver. Typically, the so-called Rayleigh fading model was used as channel model to take into account fluctuations in the amplitude and phase of signal transmission in a multipath environment in which the signal is the result of randomly distributed reflections without line of sight. So-called tap delays (TDL—“tapped delay lines”), i.e. tapped point delays, are used to represent the reflections of the multipath environment. In this respect, each tap represents a specific delay path, also referred to as a signal path (with delay), that the signal takes. Filter coefficients representing the attenuation or amplification of the amplitude of the corresponding signal path are used to take the corresponding reflection into account. These filter coefficients may be based on time-variant random processes, such as white noise. For the simulation, corresponding profiles must be retrieved, which are also referred to as “power delay profiles” (PDP) and specify the respective delay and attenuation or amplification for each tap, i.e., for each signal path, e.g., in dB.

In addition, it is known from the prior art to use a geometric model instead of the classic Rayleigh fading model for simulation. The geometric model for simulating signal transmission is particularly important for 5G applications and newer communication standards.

Instead of time-varying random processes, the filter coefficients in the geometric model are based on a sum of sinusoidal signals which represent subpaths of the signal path with the corresponding delay.

In this context, reference is also made to clusters, since a signal path corresponds to a cluster or group of several subpaths. The multiple subpaths result from physical structures in the environment, such as buildings or other obstacles, which offer similar reflection or scattering conditions, which is why clusters form. In principle, clusters can also be applied to the classic Rayleigh fading model, so that clusters or taps merely represent different approaches to represent corresponding delays between the transmitter and the receiver. In other words, the clusters or taps represent corresponding signal paths with the associated delay between the transmitter and the receiver.

However, the geometric model turned out to be disadvantageous in that numerous different physical parameters are required to define the corresponding signal path in the geometric model, for example the individual subpaths. The physical parameters include, among others, the carrier frequency, the geometry of the transmitting antennas, the geometry of the receiving antennas, the antenna pattern of the transmitting antennas, the antenna pattern of the receiving antennas, the output angle of the signals, the input angle of the signals, etc.

Due to the complexity of the required physical parameters, predefined fading profiles are thus used, which are stored in a memory and can be selected by a user for simulation. However, this results in the user being limited to the existing fading profiles for the simulation. To increase flexibility, the user may create an individual fading profile, for which the user however must know at least some of the above-mentioned physical parameters and store them accordingly. This is complicated and not user-friendly.

Accordingly, there is a need to simplify a simulation of signal transmission between a transmitter and a receiver.

### SUMMARY

According to the present disclosure, this need, or others, is satisfied, for example, by a method for configuring a channel model for signal transmission between a transmitter and a receiver. In an embodiment, the method comprises configuring N delays of the signal transmission between the transmitter and the receiver; and configuring an S×U scheme for the transmission channel between the transmitter and the receiver, wherein S is the number of transmitting antennas and U is the number of receiving antennas.

In an embodiment, the channel model comprises a total of M×N×S×U subpaths, wherein M is the number of subpaths per delay. Each of the M×N×S×U subpaths is completely described by a 3-tuple.

The basic idea is to simplify the configuration of the channel model used for simulation by requiring the user to specify only corresponding 3-tuples for the subpaths, so that the user does not have to know and enter the numerous different physical parameters. The delays describe the time delays of the signals along the corresponding signal paths. Each signal path having the corresponding delay can be defined by the M subpaths, which accordingly are completely described by the 3-tuples. User-friendliness is therefore significantly increased compared to the geometric channel model, which requires the numerous different physical parameters.

In addition, the flexibility in simulating signal transmission is increased, as the user is not limited to predefined fading profiles or the geometric channel model for simulating signal transmission. The complications associated with the geometric channel model and the physical parameters required by this model for configuration can thus be overcome.

This is ultimately because the user only has to specify the 3-tuples for the subpaths, but not the numerous physical parameters. This gives the user maximum flexibility, as the user can select the channel model themselves or adapt an existing channel model, e.g., to add further modeling components such as Faraday rotation. Unlike simulation by the geometric channel model, the user is not limited to a specific channel model, but is flexible in this regard.

For example, the user can also freely decide whether and how the antenna characteristics of the transmitter and/or receiver antennas are included in the channel model.

In this respect, the user has the freedom to freely select the antenna geometry for the transmitter and/or receiver, the beamforming characteristics for the transmitter and/or receiver, the antenna patterns for the transmitter and/or receiver, the coordinate system, and further parameters for the simulation. This applies in particular when wired tests are performed.

In addition, it is possible to easily compare real test results of a device under test (DUT) with the simulation results, since the data of the 3-tuple used for the simulation is also used for the test environment to test the device under test in a corresponding manner. For this purpose, a test device can be fed with the data of the 3-tuples so that it is configured accordingly. The configured test device can then be used for testing the device under test, so that the test results obtained can be compared with the simulation results.

In principle, the transmitter may be a base station, whereas the receiver is a terminal device, e.g., a mobile phone, a tablet, or similar. Both the transmitter and the receiver may comprise an antenna array including a plurality of antennas. Since bidirectional communication is possible, the terminal device may also be the transmitter and the base station be the receiver.

In an embodiment, a plurality of transmitting antennas and a plurality of receiving antennas may be provided, so that the transmission channel is a MIMO system. The S×U scheme therefore corresponds to a MIMO scheme.

A tuple is a mathematical object that corresponds to a list of objects. The 3-tuple therefore comprises three objects with which the corresponding subpath is defined.

According to embodiments of the present disclosure, generic channel estimation is thus possible because the underlying channel model can be abstracted.

One aspect provides, for example, that each of the N delays for signal transmission between a transmitting antenna of the transmitter and a receiving antenna of the receiver is assigned to a signal path defined by a sum of the M subpaths. The N delays thus indicate the respective delays of the N signal paths, so that the nth signal path has the nth delay. In other words, a cluster between the transmitting antenna and the receiving antenna can be described by the sum of the M subpaths. This can be expressed by the formula

$${H}_{u , s , n} ( t ) = {\sum }_{m = 1}^{M} {h}_{u , s , n} ( m ) \times {e}^{( j 2 π {f}_{D , n} ( m ) t )} ,$$

wherein m is the respective subpath of the total of M subpaths, f_{D,n}(m) corresponds to the Doppler frequency for the m-th subpath and the n-th delay of the total of N delays, and h_{u,s,n}(m) is the complex-valued amplitude of the mth subpath, which is defined by the respective transmitting antenna s, the respective receiving antenna u, and the respective delay n. The respective subpath can thus be expressed by

$${h}_{u , s , n} ( m ) \times {e}^{( j 2 π {f}_{D , n} ( m ) t )} .$$

According to one embodiment, the N delays are tap delays (TDL—“Tapped Delay Lines”). In a TDL model, the channel is modeled as a series of discrete taps, i.e., samples, each tap representing a delay and an attenuation or amplification of the signal. Each tap therefore represents a specific signal path through which the signal can travel, and each signal path has a defined delay and an associated amplification/attenuation factor.

Alternatively, the N delays are cluster delays (CDL—Clustered Delay Lines). Unlike TDL models, CDL models take the fact into account that paths often occur in clusters, i.e., groups of paths having similar delays and propagation conditions. These paths, which have similar delays and propagation conditions, are also referred to as subpaths. The subpaths then form corresponding clusters. The clusters are basically the result of physical structures in the environment of the signal transmission to be simulated, e.g., due to buildings or other obstacles that offer similar reflection or scattering conditions.

In an embodiment, the delays correspond to filter coefficients for the respective model. The model is based on the approach that the signal transmitted by the transmitter is filtered by finite impulse response (FIR) filters, which simulate the corresponding multipath propagation, i.e., the attenuation or amplification of the transmitted signal.

According to a further aspect, the entire channel model, for example, is defined by the M×N×S×U subpaths, each subpath being fully described by the 3-tuple. In this respect, the user only has to specify the corresponding 3-tuples for the subpaths to enable the simulation of signal transmission. It is up to the user to decide how to obtain the data for the 3-tuples, i.e., which model to use.

This results in a simpler option, especially in comparison with the geometric model used previously, as clearly shown by the following example.

For a typical 4×4 MIMO scheme, i.e., U=S=4, a total of N=12 delays and M=20 subpaths per delay is provided. The N=12 delays are accordingly assigned to N=12 signal paths or clusters, so that each of the signal paths has the M=20 subpaths which are completely described by the 3-tuples. This results in a total of 3,840 (=4×4×12×20) 3-tuples, i.e., a total of 11,520 numerical values, namely 3×3,840 numerical values.

Using the geometric model previously used, this would mean that for the configuration of the antenna pattern alone, which typically represents a horizontal (H) and vertical (V) polarization with respect to azimuth (−180° to 180°) and elevation (00 to 180°) with an angular resolution of 10, a total of 261,364 numerical values would be required, namely 2*2*181*361 numerical values.

This comparison clearly shows that the method(s) according to the present disclosure is significantly more user-friendly and easier to use.

According to an embodiment, the 3-tuple comprises the amplitude, the phase, and the Doppler frequency of the subpath. These three parameters can therefore be used to completely describe the respective subpath without going into the details of the subpath. This data can be obtained by the user using an appropriate model. In the geometric model, the corresponding data has been obtained in a complex manner via the numerous different physical parameters required for the geometric model. This greatly simplifies the simulation for the user.

The 3-tuples can therefore be represented by (|h_{u,s,n}(m)|, <(h_{u,s,n}(m)), f_{D,n}(m)), where |h_{u,s,n}(m)| is the amplitude, <(h_{u,s,n}(m)) is the phase, and f_{D,n}(m) is the Doppler frequency of the mth subpath.

Alternatively, the 3-tuple comprises the real part, the imaginary part, and the Doppler frequency of the subpath. Alternatively, the subpath can also be completely described on the basis of these three parameters. Once again, the user can apply an own model to obtain the corresponding data, i.e., the real part of the complex-valued amplitude of the subpath, the imaginary part of the complex-valued amplitude of the subpath, and the Doppler frequency of the subpath.

The 3-tuples can therefore be represented by ( [symbol] (h_{u,s,n}(m)), [symbol] (h_{u,s,n})(m)), f_{D,n}(m)), wherein [symbol] (h_{u,s,n})(m)) is the real part of the complex-valued amplitude of the subpath, [symbol] (h_{u,s,n}(m)) is the imaginary part of the complex-valued amplitude of the subpath, and f_{D,n}(m) is the Doppler frequency of the mth subpath.

A further aspect provides, for example, that the parameters for configuring the channel model are specified by a user, for example the 3-tuples for the subpaths. In this respect, the user specifies the 3-tuples for the subpaths, based on which the signal transmission is simulated. The user can apply an individual model to obtain the data of the 3-tuples, which gives the user corresponding flexibility in simulating signal transmission.

The present disclosure also relates to a number of test devices for simulating signal transmission between a transmitter and a receiver. In an embodiment the test device has a processor that is set up to configure a channel model for signal transmission based on one or more of aforementioned methods. The aforementioned advantages are thus obtained in an analogous manner for the test device.

One aspect provides, for example, that the test device, for example the processor, is set up to provide a graphical user interface via which a user can enter the parameters for configuring the channel model, for example the 3-tuples for the subpaths. The graphical user interface, GUI, can be simple in design, as the user only has to specify the 3-tuples for the subpaths. The user is thus provided with an interface via which the user can directly specify the total of U×S×N×M 3-tuples. As already explained above, this is significantly less complex than providing the physical parameters for the geometric channel model.

According to a further aspect, the test device, for example, has an interface via which a command for configuring the channel model can be received. In this respect, the data can also be transmitted to the test device via a computer, so that no input by the user is required.

A further aspect provides that the test device, for example, is set up to implement the received parameters for configuring the channel model such that the test device is configured accordingly.

In an embodiment, the test device may be a signaling tester which is set up to test a device to be tested, e.g., to perform wired tests. The tests to be performed with the test device may be RF conformance tests.

In an embodiment, the hardware may include, among other things, a central processing unit (CPU), a graphics processing unit (GPU), a field-programmable gate array (FPGA), an application-specific integrated circuit (ASIC), or other types of electronic circuitry.

Basically, the method(s) can be applied both to channel components which are not in the line of sight, i.e., the so-called “non line of sight” (NLOS) channel components, and to channel components that are in the line of sight, i.e., the so-called “line of sight” (LOS) channel components. The LOS channel components typically comprise U×S subpaths, each of these subpaths being also fully described by a corresponding 3-tuple.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows a schematic overview of signal transmission between a transmitter and a receiver,

FIG. 2 shows an overview illustrating the method according to an embodiment of the present disclosure,

FIG. 3 shows an overview illustrating the Rayleigh fading model known from the prior art, and

FIG. 4 shows an overview illustrating the geometric model known from the prior art.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

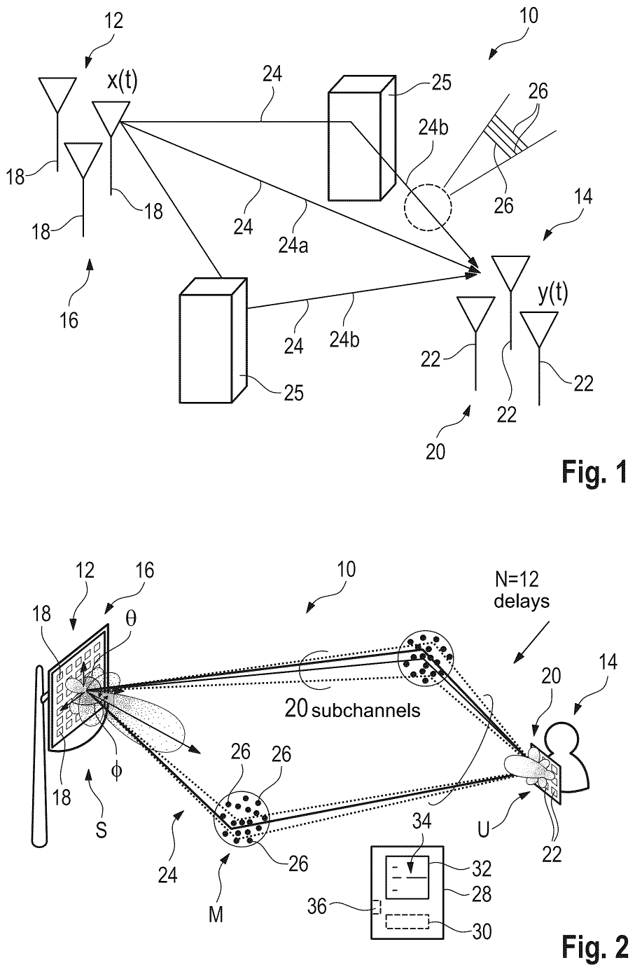

FIG. 1 shows a system 10 comprising a transmitter 12 and a receiver 14 between which signal transmission is carried out. The transmitter 12 transmits the signal x(t), which is received by the receiver 14 as the signal y(t). This is due to the channel or transmission from the transmitter 12 to the receiver 14.

The transmitter 12, which is, for example, a base station, has a transmitter antenna array 16 including a plurality of transmitting antennas 18, whereas the receiver, which is, for example, a terminal device, has a receiver antenna array 20 including a plurality of receiving antennas 22.

The signal transmission between the transmitter 12 and the receiver 14 can run via different signal paths 24, each of which may have its own delay. This is because, in addition to direct signal transmission, i.e., a direct signal path 24a, reflections from obstacles 25 such as buildings can also occur, resulting in multipath propagation of the signal, i.e., indirect signal paths 24b. Each of these signal paths 24 results in a different delay due to the respective reflection.

The corresponding signal paths 24 that arise due to the delays are also referred to as clusters or taps. A signal path 24 can therefore correspond to a cluster or a group of several subpaths 26, as indicated in FIG. 2.

The several subpaths 26 result, for example, from the physical structures in the environment, such as buildings or other obstacles, which offer similar reflection or scattering conditions, which is why the subpaths 26 form clusters.

To simulate such signal transmission between the transmitter 12 and the receiver 14, a plurality of subpaths 26 is therefore assumed for each delay or each signal path 24, so that each of the signal paths 24 having the corresponding delay is defined for signal transmission by a sum of the plurality of subpaths 26.

As the transmitter 12 comprises a plurality of transmitting antennas 18 and the receiver 14 comprises a plurality of receiving antennas 22, this applies to the signal transmission between one of the plurality of transmitting antennas 18 of the transmitter 12 and one of the plurality of receiving antennas 22 of the receiver 14.

In other words, it may be provided for the simulation that there is a total of N signal paths 24, i.e., N delays, between the transmitter 12 and the receiver 14. The transmitter 12 has a total of S transmitting antennas 18, whereas the receiver 14 has a total of U receiving antennas 22, so that an S×U scheme describes the transmission channel between the transmitter 12 and the receiver 14.

The number of subpaths 26 per delay or signal path 24 is denoted by M, resulting in the following relationship.

$${H}_{u , s , n} ( t ) = {\sum }_{m = 1}^{M} {h}_{u , s , n} ( m ) \times {e}^{( j 2 π {f}_{D , n} ( m ) t )}$$

Here, m is the respective subpath 26 of the total of M subpaths 26, wherein f_{D,n}(m) is the Doppler frequency for the mth subpath 26 and the nth delay of the total of N delays, and wherein h_{u,s,n}(m) is the complex-valued amplitude of the mth subpath 26, which is defined by the respective transmitting antenna 18, denoted by s, the respective receiving antenna 22, denoted by u, and the respective delay n of the N delays. The subpath 26 itself can thus be described by

$${h}_{u , s , n} ( m ) \times {e}^{( j 2 π {f}_{D , n} ( m ) t )} .$$

In other words, there are a total of N delays or N signal paths 24 having a delay, S transmitting antennas 18, U receiving antennas 22, and M subpaths 26 per delay or signal path 24, wherein the respective delay is designated by n, the respective transmitting antenna 18 is designated by s, the respective receiving antenna 22 is designated by u, and the respective subpath 26 of the corresponding delay is designated by m.

The respective subpath 26 is completely described by a 3-tuple comprising the amplitude, the phase, and the Doppler frequency of the respective subpath 26. The 3-tuples can therefore be represented by (|h_{u,s,n}(m)|, <(h_{u,s,n}(m)),f_{D,n}(m)), wherein |h_{u,s,n}(m)| is the amplitude, <(h_{u,s,n}(m)) is the phase, and f_{D,n}(m) is the Doppler frequency of the mth subpath.

Alternatively, the 3-tuples for the subpaths 26 may comprise the real part, the imaginary part, and the Doppler frequency of the respective subpath 26. The 3-tuples can therefore also be represented by ( [symbol] (h_{u,s,n}(m))|, [symbol] (h_{u,s,n}(m)),f_{D,n}(m)), wherein [symbol] (h_{u,s,n}(m)) is the real part of the complex-valued amplitude of the subpath, [symbol] (h_{u,s,n}(m)) is the imaginary part of the complex-valued amplitude of the subpath, and f_{D,n}(m) is the Doppler frequency of the mth subpath.

For a 4×4 MIMO scheme, in which the transmitter 12 thus comprises two transmitting antennas 18 and the receiver 14 comprises two receiving antennas 22, so that U=S=4, a total of N=12 delays or signal paths 24 with the delay can be provided, i.e., clusters or tabs. Twenty subpaths 26 can be provided per delay or signal path 24 with the delay, so that M=20 applies. This is shown accordingly in FIG. 2.

This results in a total of 3,840 different 3-tuples for describing the channel to be simulated for signal transmission between the transmitter 12 and the receiver 14, since U×S×N×M=4×4×12×20=3,840 applies. This results in a total of 11,520 numerical values, namely 3×3,840 numerical values, which are required to simulate the channel for signal transmission between the transmitter 12 and the receiver 14.

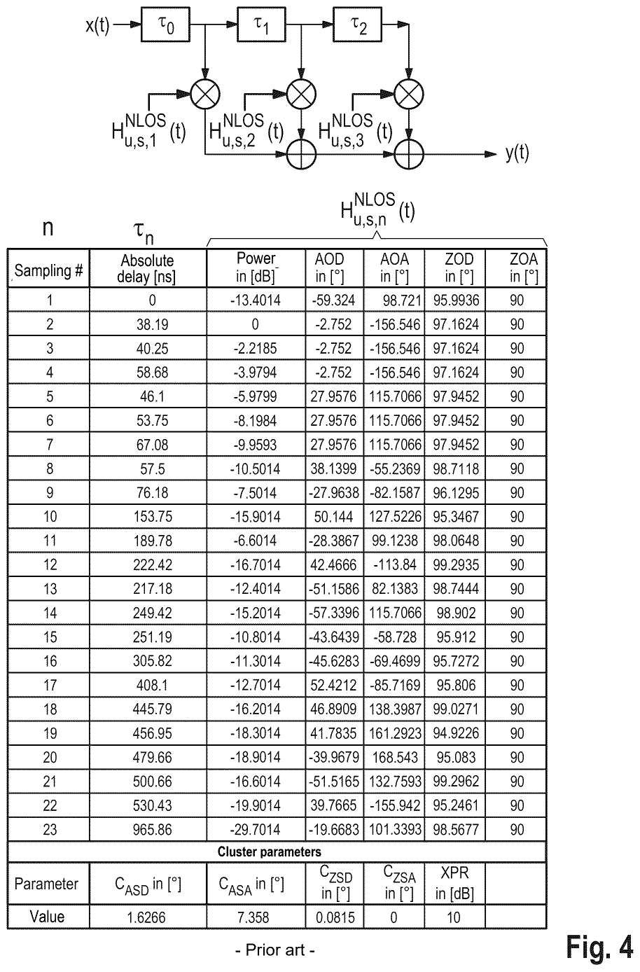

Compared to the geometric model known from the prior art, which is schematically visualized in FIG. 4, significantly less data is therefore required, since a total of 261,364 numerical values were required for the configuration of the antenna pattern alone in the geometric model known from the prior art. This is because the antenna pattern was typically determined for horizontal (H) and vertical (V) polarization with respect to azimuth (−180° to 180°) and elevation (00 to 180°) at an angular resolution of 1°, resulting in 2*2*181*361=261,364 numerical values.

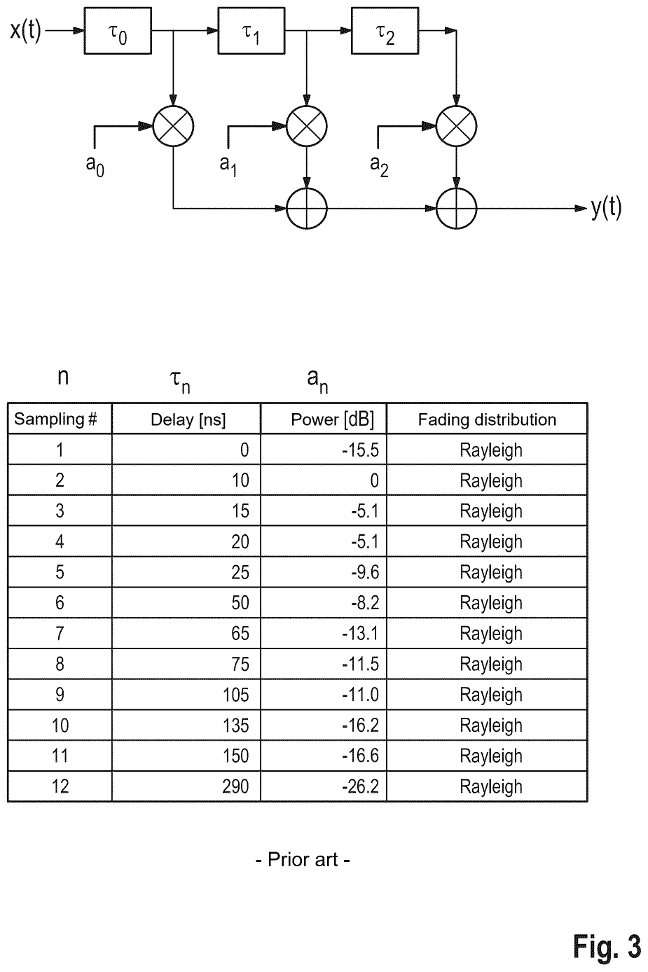

Clearly, the methods of the present technology for configuring a channel model for simulating signal transmission between the transmitter 12 and the receiver 14 is more streamlined and user-friendly compared to the geometric model known from the prior art. FIG. 3 also shows the simplified Rayleigh fading model.

According to the present technology, the entire channel model is defined by the M×N×S×U subpaths 26, each subpath 26 being completely described by the 3-tuple.

The 3-tuples for the subpaths 26 are specified by the user. In this respect, the user specifies the parameters for configuring the channel model.

For this purpose, a test device 28 may be provided, comprising a processor 30 and a display 32 on which a graphical user interface 34 is displayed. The user can configure the N delays of the signal transmission between the transmitter 12 and the receiver 14 and the S×U scheme for the transmission channel between the transmitter 12 and the receiver 14 via the graphical user interface 34. In an embodiment, the user enters the respective 3-tuples for the M subpaths 26 per delay via the graphical user interface 34, since the 3-tuples completely describe the respective subpath 26. The sum of the subpaths 26 then describes the corresponding signal path 24, which has the assigned delay.

The test device 28 is basically set up to simulate the corresponding signal transmission between the transmitter 12 and the receiver 14 based on the inputs of the user.

Furthermore, the test device 28 can be configured accordingly based on the inputs so that the test device 28 tests a device to be tested according to the input data of the user, e.g., the receiver 14.

The test results obtained in this way, the tests of which were defined based on the 3-tuples, can then be compared with the simulation results, which were also obtained based on the 3-tuples.

In addition, the test device 28 may have an interface 36 via which a command for configuring the channel model can be received. The data can be transmitted from an external device to the test device 28, e.g., a server.

In any case, due to the 3-tuples, which completely describe the respective subpath 26, it is possible to provide a generic channel model based on which the channel estimation or the simulation of the signal transmission between the transmitter 12 and the receiver 14 is performed.

The respective signal paths 24 between the transmitter 12 and the receiver 14, which are taken into account for the channel estimation or the simulation of the signal transmission, result from corresponding sums of the subpaths 26.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be used synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components of the system 10, etc., referenced above include circuitry programmed to carry out one or more steps or actions of any of the methods disclosed herein. In an embodiment, one or more computer-readable media associated with or accessible by such circuitry contains computer readable instructions embodied thereon that, when executed by such circuitry, cause the component or circuitry to perform one or more steps or actions of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A method for configuring a channel model for signal transmission between a transmitter and a receiver, comprising:
configuring N delays of the signal transmission between the transmitter and the receiver, and
configuring an S×U scheme for the transmission channel between the transmitter and the receiver, wherein S is the number of transmitting antennas and U is the number of receiving antennas,
wherein the channel model comprises a total of M×N×S×U subpaths, wherein M is the number of subpaths per delay, and
wherein each of the M×N×S×U subpaths is completely described by a 3-tuple.

2. The method according to claim 1, wherein each of the N delays for signal transmission between a transmitting antenna of the transmitter and a receiving antenna of the receiver is assigned to a signal path defined by a sum of the M subpaths.

3. The method according to claim 2, wherein the signal path is defined by the following formula:
$${H}_{u , s , n} ( t ) = {\sum }_{m = 1}^{M} {h}_{u , s , n} ( m ) \times {e}^{( j 2 π {f}_{D , n} ( m ) t )} .$$

4. The method according to claim 1, wherein the N delays are cluster delays or tap delays or are filter coefficients.

5. The method according to claim 1, wherein the N delays are cluster delays or tap delays or are filter coefficients for filters with finite impulse response.

6. The method according to claim 1, wherein the entire channel model is defined by the M×N×S×U subpaths, wherein each subpath is completely described by the 3-tuple.

7. The method according to claim 1, wherein the 3-tuple comprises the amplitude, the phase, and the Doppler frequency of the subpath, or the 3-tuple comprises the real part, the imaginary part, and the Doppler frequency of the subpath.

8. The method according to claim 1, wherein the parameters for configuring the channel model are specified by a user.

9. The method according to claim 1, wherein the parameters for configuring the channel model are specified by the 3-tuples for the subpaths.

10. A test device for simulating a signal transmission between a transmitter and a receiver, the test device comprising a processor that is set up to configure a channel model for the signal transmission according to the method of claim 1.

11. The test device according to claim 10, wherein the test device is set up to provide a graphical user interface via which a user can enter the parameters for configuring the channel model.

12. The test device according to claim 10, wherein the test device is set up to provide a graphical user interface via which a user can enter the 3-tuples for the subpaths.

13. The test device according to claim 10, wherein the test device has an interface via which a command for configuring the channel model can be received.

14. The test device according to claim 10, wherein the test device is set up to implement the received parameters for configuring the channel model such that the test device is configured accordingly.
